(19) United States
(12) Patent Application Publication
(10) Pub. No.: US 2024/0425776 A1
(43) Pub. Date: Dec. 26, 2024

(54) ADSORPTIVE PURIFICATION OF A RENEWABLE FEEDSTOCK

(71) Applicant: Neste Oyi, Espoo, FL (US)

(72) Inventors: Ronny WAHLSTRÖM, Porvoo (FI); Annika MALM, Porvoo (FI)

(73) Assignee: Neste Oyj, Espoo, FL (US)

(21) Appl. No.: 18/700,288

(22) PCT Filed: Oct. 20, 2022
(86) PCT No.: PCT/EP2022/079223

§ 371 Date: Apr. 11, 2024

(30) Foreign Application Priority Data
Oct. 22, 2021 (FI) 20216100

(51) Int. Cl. C11B 3/10; C11B 3/00

(52) U.S. Cl. CPC C11B 3/10; C11B 3/001; C11B 3/008

(57) ABSTRACT

Present invention relates to a novel process for purification of feedstocks.

### FIELD OF INVENTION

Present invention relates to a process for reducing or removing one or more demulsifiers present in a feedstock. Present invention also relates to a feedstock obtainable by a process according to the invention as well as a purified feedstock with reduced amounts of one or more demulsifiers or complete elimination thereof. Furthermore, present invention relates to use of an adsorbent material for purifying a feedstock comprising one or more demulsifiers. Finally, present invention relates to use of a purified feedstock according to the invention for further use as a raw material or starting material for further preparation of a fuel component, or for further use as a component or starting material for fine chemicals.

### BACKGROUND OF THE INVENTION

Distiller's corn oil or Technical corn oil (TCO) is produced as a by-product from corn ethanol production. When processing TCO, the presence of polysorbate typically in a concentration of ca. 0.4 wt-%, which is used as a demulsifier in the TCO separation process, has shown to be a challenge for a pretreatment processes aiming at removing nitrogen, phosphorous and metal impurities in the feedstock. A high amount of polysorbate may contribute to cake accumulation in filtration tentatively leading to shorter filtration cycles. Further, the presence of even 0.1 wt-% polysorbate could deteriorate purification of phosphorous and metals in pretreatments.

Various prior art techniques have been presented in the field of purifying feedstocks. However, the present invention is able to meet the need for a simple, inexpensive and very effective method for removing demulsifiers from a feedstock such as a renewable feedstock. The present invention enables reduction or complete removal of demulsifiers from feedstocks optionally in addition to removal of also phosphorous containing compounds and metals or metal containing compounds.

### SUMMARY OF THE INVENTION

In one aspect, present invention relates to a method or process for reducing or removing one or more demulsifiers present in a feedstock.

Specifically, the invention relates to a process that may comprise the use of an adsorbent material, and wherein the process may further comprise;
i) providing said feedstock comprising one or more demulsifiers,
ii) contacting said feedstock with the adsorbent material, and thereafter
iii) separating said feedstock from the adsorbent material,
   to thereby obtain a purified feedstock with a reduced amount of one or more demulsifiers.

In one aspect, the present invention relates to a process for reducing or removing one or more demulsifiers present in a feedstock, wherein the process may comprise
i) providing said feedstock comprising one or more demulsifiers,
ii) contacting said feedstock with an adsorbent material, wherein the adsorbent material has been surface activated by acid treatment, and thereafter
iii) separating said feedstock from the adsorbent material,
   to thereby obtain a purified feedstock with a reduced amount of one or more demulsifiers.

In one aspect, the present invention relates to a process for reducing or removing one or more demulsifiers present in a feedstock, wherein the process may comprise the use of an adsorbent material optionally in an amount of 0.1 wt % to 3 wt % based on the weight of the feedstock, and wherein the process further comprises;
i) providing said feedstock comprising one or more demulsifiers,
ii) contacting said feedstock with the adsorbent material, wherein the adsorbent material has been surface activated by acid treatment, and thereafter
iii) separating said feedstock from the adsorbent material,
   to thereby obtain a purified feedstock with a reduced amount of one or more demulsifiers.

In yet a further aspect, present invention relates to a process for reducing or removing one or more demulsifiers present in a feedstock, wherein the process comprises adding an adsorbent material optionally to the feedstock and/or to a filter which can optionally be used for separating said feedstock from the adsorbent material.

In another aspect, present invention relates to a process for reducing or removing one or more demulsifiers present in a feedstock, wherein the process comprises the use of an adsorbent material.

It is thus an aim of the invention to remove at least part of one or more demulsifiers used in a previous process or otherwise still present in a feedstock. In one aspect, the obtained purified feedstock may be essentially free of the one or more demulsifiers. In another aspect, the process may provide for a purified feedstock comprising reduced amounts of the one or more demulsifiers.

In another aspect, it is a further aim of the invention to remove or eliminate the presence of demulsifiers so as to reduce or eliminate problems with purifying the feedstock from nitrogen, and/or phosphorous, and/or metal containing compounds present in the feedstock.

In another aspect, the obtained purified feedstock may comprise the one or more demulsifiers in amounts that are below what is possible to analytically detect by standard analytical methods.

Thus in one aspect, present invention relates to a purified feedstock obtainable or obtained by the process according to the invention, wherein the purified feedstock may comprise a lipid material or an oil separated from a distillation residue and further comprising a demulsifier in an amount of e.g. about 0.3 wt % or less, or below detection level of any analytical method.

In a further aspect, present invention relates to the use of an adsorbent material for purifying a feedstock comprising one or more demulsifiers and optionally a lipid material such as a lipid material separated from a distillation residue.

In yet a further aspect, present invention relates to the use of the purified feedstock or any mixture thereof obtainable or obtained according to process according to the invention for the preparation of a fuel, fuel component or fine chemicals.

### DEFINITIONS

By the term “adsorbent material” in the context of present invention is intended to mean any suitable material capable of adsorbing a selected class of agent or agents. In a non-limiting context the adsorbent material may be a mineral based material or a surface activated or treated material such as e.g. a surface activated or treated mineral based material. In a further non-limiting aspect, the adsorbent material is intended to encompass but not being limited to a mineral adsorbent comprising or consisting of one or more materials based on diatomaceous earth, diatomite, perlite, bentonite, palygorskite, kaoline, kaolinite, silica, sepiolite, and/or various cellulose fibers, or any combination thereof.

By the term “surface activated” in the context of present invention is intended to mean any process which is capable of changing the characteristics of the adsorbent material such as mineral based material in terms of its ability to increase e.g. an adsorption of a class of agent or agents, such as one or more demulsifiers. Such process may entail treating the adsorbent material with an acid for a certain amount of time to allow for activation of the material. The acid may for example be, but is not limited to, sulphuric acid, hydrochloric acid, or nitric acid or the likes, or any combination thereof. Moreover in one embodiment, in the context of surface activation, an adsorbent or mineral-based material used in filtration and/or purification of organic feeds such as lipid oils (but not limiting to lipid oils) has been surface activated in order to be able to adsorb significant amounts of one or more demulsifiers and optionally further feed impurities such as (but not limiting to) soaps, metals, phosphorus containing compounds, phospholipids etc. Surface activation is achieved typically by a boiling treatment in mineral acid (e.g.

sulphuric acid, nitric acid or hydrochloric acid) where after the adsorbent is washed to remove excess acid, the treated adsorbent is dried to suitable moisture content and optionally ground or treated to have suitable particle size for optimised adsorption and/or filtration properties. The surface activation may increase or significantly increase the adsorbent surface area e.g. through introducing pores, which gives more surface area for adsorption. In addition or alternatively to increasing the surface area, the adsorbent surface such as mineral surface may be activated chemically to have better adsorbent properties. For example, a mineral-based surface-activated adsorbent (e.g. a mineral-based surface-activated filter aid) can have properties of both a mineral-based, activated adsorbent and a typical filter aid: the activation step has given it properties to adsorb impurities, whereas its general filtration aid properties, e.g. its particle size optimised for supporting smooth filtration, gives it desirable filtration properties. In general, “a filter aid” may be a solid used in filtration to improve the filtration flux and/or to form the filter cake through which the fluid to be purified is filtered. In one embodiment of the invention the adsorbent has both adsorption and filter aid properties.

A typical way to activate an adsorbent or a mineral for increased adsorption properties is to boil it for several hours in an aqueous solution of a mineral acid, wash the activated adsorbent or mineral by water to remove excess acid, dry the activated adsorbent or mineral and optionally grind it to suitable particle size.

By the term “demulsifier” in the context of present invention is intended to mean e.g. a polysorbate based compound, such as e.g. an ethoxylated sorbitan, or e.g. Polysorbate 20 (polyoxyethylene (20) sorbitan monolaurate), Polysorbate 40 (polyoxyethylene (20) sorbitan monopalmitate), Polysorbate 60 (polyoxyethylene (20) sorbitan monostearate), Polysorbate 80 (polyoxyethylene (20) sorbitan monooleate), or any type of surfactant such as e.g. a sorbitan based compound, e.g. sorbitan monooleate and the likes, or any mixtures or combinations thereof. Basically, the demulsifier may in principle be any agent capable of breaking an emulsion such that phase separation occurs or wherein phase separation is facilitated.

By the term “feedstock” in the context of present invention is intended to mean any feedstock comprising carbon and one or more demulsifiers. In one aspect, the feedstock comprises a lipid material. In one embodiment the feedstock or the lipid material of the feedstock is from a renewable and/or organic material. Such lipid material may comprise one or more of any plant oils, plant fats, animal fats, animal oils, fish fats, fish oils, microbial oils, algae oils, waste fats, waste oils, residue fats, residue oils, a sludge originating from plant oil production and mold oils (optionally selected from e.g. rapeseed oil, canola oil, colza oil, tall oil, sunflower oil, corn oil, technical/distillers corn oil (TCO), soybean oil, hemp oil, olive oil, linseed oil, cottonseed oil, mustard oil, palm oil, palm oil mill effluent (POME), arachis oil, castor oil, coconut oil, animal fats such as e.g. suet, tallow, blubber, recycled alimentary fats, used cooking oil, brown grease, acid oils), starting or lipid materials produced by genetic engineering, and biological starting or lipid materials produced by microbes such as algae and bacteria and the likes, or any combinations or mixtures thereof. By the term “filter” in the context of present invention is intended to mean any device or material known in the art commonly used to separate a solid phase from a liquid phase. Non-limiting examples are e.g. any type of filter medium, or a grid, or a net, or a porous glass disk, or a paper/cellulose based material, or a membrane of any kind or based on any material. The filter may also additionally or optionally be combined with the adsorbent material such that the adsorbent material is applied onto or otherwise combined with the filter.

By the term “degumming” in the context of present invention is intended to mean any process aimed at removal of e.g. phospholipids from vegetable oils. Degumming may be made by the aid of water and/or acid, such as e.g. aqueous acid solution, which may be mixed with the feedstock e.g. by high shear mixing, whereafter phase-separation between the aqueous phase and purified feedstock is achieved e.g. in centrifuges or separators.

By the term “bleaching” in the context of present invention is intended to mean any process which aims at minimizing the content of e.g. pigments (e.g. carotenes and chlorophylls), metals, heavy metals, and/or the phosphorus in a feedstock. The bleaching may be applied in combination with degumming. Bleaching may comprise an adsorbent treatment step with an adsorbent such as a mineral based adsorbent and after contacting time with adsorbent is completed, a step for removing the adsorbent e.g. by filtration. Optionally, the adsorption step may be preceded by high shear mixing the feedstock with an aqueous acid solution followed by some retention time, before addition of an adsorbent.

### DETAILED DESCRIPTION OF THE INVENTION

Present invention provides for a process for purification of feedstocks which effectively reduces one or more demulsifying agents such as polysorbate and optionally some or the majority of phosphorous and metal contents. Thus, the obtained purified feedstock is a very pure blending component enabling use together with low-quality feeds. This invention makes it possible to treat higher concentrations of previously non-preferred or difficult feedstocks such as TCO in the feed blend. Importantly, the present invention provides for a process suitable for large industrial scale treatment of renewable feedstocks.

Feedstocks comprising unacceptable high levels of demulsifiers can be generally considered unsuitable or not preferred for any further use. However, the method of present invention is able to purify feedstocks comprising high amounts of demulsifiers (e.g. polysorbate) which demulsifiers may contribute to cake accumulation in filtration tentatively leading to shorter filtration cycles. Thus, present invention enables use of specific feedstocks for further processing including but not limited to a preparation of a fuel, fuel component or fine chemicals.

Consequently, present invention relates to a method or process for reducing or removing one or more demulsifiers present in a feedstock.

Specifically, the invention relates to a process that may comprise the use of an adsorbent material, and wherein the process may further comprise;
i) providing said feedstock comprising one or more demulsifiers,
ii) contacting said feedstock with the adsorbent material, and thereafter
iii) separating said feedstock from the adsorbent material,
   to thereby obtain a purified feedstock with a reduced amount of one or more demulsifiers.

It is thus an aim of the invention to remove one or more demulsifiers used in a previous process or otherwise still present in a feedstock. The feedstock may thus have undergone one or more previous processes.

In one aspect, the process may optionally comprise bleaching the feedstock comprising the one or more demulsifiers present in the non-purified feedstock. For example, contacting the feedstock with an adsorbent material may be the bleaching or a part of the bleaching.

In certain aspect of the invention, the process may comprise or include one or more steps preceding the method steps according to any of the claims.

In one aspect, the process may not include or comprise degumming and/or bleaching.

In a further aspect, the process may include or comprise degumming and/or bleaching.

The feedstock according to the invention may comprise one or more demulsifiers in any amount, for example in an amount of about 0.05 to about 2 wt %, such as e.g. about 0.1 to about 2 wt %, such as e.g. about 0.1 to about 1 wt %, or more prior to be contacted with an adsorbent material according to the invention. In another aspect, the demulsifier may be present in an amount of e.g. from 0 wt % to about 0.8 wt %, or about 0.3 wt %, or about 0.4 wt %.

In one aspect, the obtained purified feedstock may be essentially free of the one or more demulsifiers. In another aspect, the process may provide for a purified feedstock comprising reduced amounts of the one or more demulsifiers.

In another aspect, the obtained purified feedstock may comprise reduced amounts of the one or more demulsifiers in amounts that are below what is possible to analytically detect by standard analytical methods.

In one aspect, the amount of the one or more demulsifiers in the purified feedstock may be about 25% or less in relation to the amount of the demulsifier of the feedstock to be purified, such as e.g. 20% or less, 15% or less, 10% or less, 5% or less, 2% or less or 1% or less of the original amount of demulsifiers present in the non-purified feedstock.

Consequently, according to the invention the purified feedstock may comprise an amount of the demulsifier of the purified feedstock in range of e.g. 0 wt % to about 0.3 wt % or e.g. about 0.1 wt % to about 0.2 wt %, or below levels which may be detected by any analytical method. In one embodiment the one or more demulsifiers of the purified feedstock are in an amount of about 0.3 wt % or less, about 0.2 wt % or less, about 0.1 wt % or less, or below detection level of any analytical method.

Moreover, the purified feedstock according to the invention may display reduced amounts of phosphorous containing compounds (such as e.g. phosphatides etc.)

and/or metals. Thus, in one aspect, the amount of phosphorus and/or metals of the purified feedstock may be about 20% or less in relation to the amount of phosphorus and/or metals of the feedstock to be purified, such as e.g. 15% or less, 10% or less, 5% or less, 2% or less or 1% or less of the contents thereof as compared with the amounts seen in the feedstock material before being processed according to the invention.

Thus in one aspect, present invention relates to a purified feedstock obtainable or obtained by the process according to the invention, wherein the purified feedstock may comprise a lipid material separated from a distillation residue or an oil separated from a distillation residue and further comprising a demulsifier in an amount of e.g. about 0.3 wt % or less, or below detection level of any analytical method.

According to the invention, the adsorbent material may consist of or comprise a mineral based material. Such mineral based material may consist of or comprise e.g.

diatomaceous earth, diatomite, perlite, bentonite, palygorskite, kaoline, kaolinite, silica, and/or sepiolite, or any combination thereof.

In one particular aspect, the adsorbent material is or may comprise bentonite and particularly acid-activated bentonite or acid treated bentonite.

According to one aspect of the invention, the adsorbent material has been activated prior to being used in the process according to the invention. Activation may be any type of activation aiming at surface activation of the adsorbent. Such activation may take place by the aid of acid treatment of the adsorbent material. Surface activation may be achieved typically by a boiling treatment in mineral acid (such as e.g. sulphuric acid, nitric acid or hydrochloric acid, or any combination thereof) where after the adsorbent is washed to remove excess acid, the treated adsorbent is dried to suitable moisture content and optionally ground or otherwise treated to have suitable particle size for optimised adsorption and optionally filtration properties.

In one aspect of the invention the surface activation increases or significantly increases the surface area of the adsorbent (such as mineral) material e.g. through introducing pores, which gives more surface area for adsorption. In addition or alternatively to increasing the surface area, the adsorbent surface can be activated chemically to have better adsorbent properties (e.g. by surface acidity). Surface activation can be carried out in one or more steps, for example with aid of one or more surface activation agents. In one embodiment, one surface activation agent such as an acid increases both the adsorbent surface area and the chemical adsorbent properties of the adsorbent material.

Thus in one aspect, the surface activated adsorbent material may have a pore size (pore width) of e.g. less than about 1 μm, less than about 0.1 μm, less than about 0.05 μm, less than about 0.002 μm, or e.g., about 0.002 to about 0.05 μm.

In another aspect, the adsorbent material may have a permeability in a range from about 0.1 to about 20 darcies, about 0.2 to about 2.5 darcies, about 0.2 to about 1 darcies or about 0.5 to about 1.0 darcies, or preferably 0.2-1 Darcy.

In yet a further aspect, the adsorbent material may have particle sizes in any distribution or range of about 1 μm to about 1000 μm, such as e.g. about 1 μm to about 500 μm, about 1 μm to about 100 μm, about 10 μm to about 500 μm, about 10 μm to about 100 μm, such as e.g. about 50 μm to about 250 μm, preferably 1 μm to about 1000 μm. In a specific aspect the adsorbent material comprises or consist of particle sizes in any distribution or range of from about 1 μm to about 100 μm.

In a specific aspect of the invention, the adsorbent material may be characterized by having surface area of about 100 m²/g or more, such as e.g. about 250 m²/g or more, about 300-400m²/g or more, or about 500 m²/g or more, such as e.g. about 1000 m²/g or more.

The adsorbent material according to the invention is able to adsorb one or more demulsifiers of a feedstock and may further have the capability to adsorb phosphorus containing compounds and/or metals etc. Thus, in one aspect, present invention provides for a process wherein the obtained purified feedstock further displays reduced amounts of phosphorous containing compounds and/or metals, or is essentially free of phosphorous containing compounds and/or metals.

The feedstock according to the invention may in principle comprise or be any lipid based material. The feedstock, such as the feedstock comprising a lipid material, may comprise one or more of any plant oils, plant fats, animal fats, animal oils, fish fats, fish oils, microbial oils, algae oils, waste fats, waste oils, residue fats, residue oils, a sludge originating from plant oil production, a fatty acid distillate, acidulated soapstock, mold oils, rapeseed oil, canola oil, colza oil, babassu oil, carinata oil, coconut butter, muscat butter oil, sesame oil, maize oil, poppy seed oil, cottonseed oil, soy oil, laurel seed oil, jatropha oil, palm kernel oil, camelina oil, tall oil, fraction of tall oil, crude tall oil, tall oil pitch, sunflower oil, corn oil, technical/distillers corn oil (TCO), soybean oil, hemp seed oil, olive oil, linseed oil, cottonseed oil, mustard oil, mustard seed oil, peanut oil, castor oil, coconut oil, palm oil, crude palm oil, palm seed oil, palm fatty acid distillate, palm oil mill effluent, arachis oil, castor oil, coconut oil, archaeal oil, bacterial oil, fungal oil, protozoal oil, algal oil, seaweed oil, oils from halophiles, poultry fat, dry rendered poultry fat, brown grease, used cooking oil, suet, lard, tallow, blubber, recycled alimentary fats, acid oil, train oil, spent bleaching earth oil, lignocellulosic based feeds, materials produced by genetic engineering, and biological materials produced by microbes, or any combinations or mixtures thereof.

In one aspect, the feedstock can contain e.g. at least 5 wt %, at least 10 wt %, at least 20 wt %, at least 30 wt %, or at least 40 wt %, of fats, oils or their derivatives, or a combination thereof. The fats or oils may be plant oils, plant fats, animal fats, animal oils, fish fats, fish oils, microbial oils and/or algae oils.

Indeed, the feedstock optionally comprising a lipid material can be any kind of animal and/or plant based material. Typically, the feedstock contains for example triglycerides and/or free fatty acids. In one aspect the feedstock contains distilled free fatty acids. In an embodiment, the feedstock is selected from the group consisting of:
plant fats, plant oils, plant waxes; animal fats, animal oils, animal waxes; fish fats, fish oils, fish waxes;
fatty acids or free fatty acids obtained from plant fats, plant oils, plant waxes; animal fats, animal oils, animal waxes; fish fats, fish oils, fish waxes, and mixtures thereof by hydrolysis, transesterification or pyrolysis;
esters obtained from plant fats, plant oils, plant waxes; animal fats, animal oils, animal waxes; fish fats, fish oils, fish waxes; and mixtures thereof by transesterification;
metal salts of fatty acids obtained from plant fats, plant oils, plant waxes; animal fats, animal oils, animal waxes; fish fats, fish oils, fish waxes, and mixtures thereof by saponification;
esters obtained by esterification of free fatty acids or plant, animal and fish origin with alcohols;
fatty alcohols or aldehydes obtained as reduction products of fatty acids from plant fats, plant oils, plant waxes; animal fats, animal oils, animal waxes; fish fats, fish oils, fish waxes, and mixtures thereof;
recycled food grade fats and oils, and fats, oils and waxes obtained by genetic engineering;
dicarboxylic acids or polyols including diols, hydroxyketones, hydroxyaldehydes, hydroxycarboxylic acids, and corresponding di-or multifunctional sulphur compounds, corresponding di-or multifunctional nitrogen compounds;
compounds derived from algae, and
mixtures of any of these materials.

In one aspect, the feedstock is based on an edible oil/fat or a non-edible oil/fat or a combination thereof. In another aspect, the feedstock comprises plant oil. In a further aspect, the plant oil is obtained as a by-product from the industry. According to a particular aspect, the feedstock is selected from waste and residues from animal fat or oil, plant fat or oil, and fish fat or oil, and mixtures thereof.

An exemplary feedstock comprises at least triglycerides. Most typical exemplary feedstocks are animal fats and palm oil fatty acid, especially those originating from waste and residues.

A further exemplary feedstock comprises at least fatty acids. Most typical feedstock are various plant oils, and e.g. tall oil materials, such as crude tall oil.

The natural fats or oils or derivatives thereof may be provided in pure form or as part of a feedstock containing other components. The feedstock can contain e.g. at least 5 wt %, at least 10 wt %, at least 20 wt %, at least 30 wt %, or at least 40 wt %, of pure natural fat or natural oil or their derivatives.

The feedstock may comprise C₈-C₂₄ fatty acids, derivatives of said fatty acids, such as esters of fatty acids as well as triglycerides of fatty acids, metal salts of said fatty acids, or combinations of thereof. The fatty acids or fatty acid derivatives, such as esters may be produced via hydrolysis of bio-oils or by their fractionalization, or by esterification reactions of triglycerides.

The feedstock may also include derivatives of natural fats including mono-or diglycerides of C₁₀-C₂₈ fatty acids, C₁₀-C₂₈ fatty acids, non-glyceride C₁₀-C₂₈ fatty acid esters, C₁₀-C₂₈ fatty alcohols, C₁₀-C₂₈ fatty aldehydes and C₁₀-C₂₈ fatty ketones. The C₁₀-C₂₈ fatty acids, their mono-and diglycerides, are typically prepared by hydrolysis of the corresponding triglyceride. The non-glyceride C₁₀-C₂₈ fatty acid esters are mainly prepared from the triglycerides by transesterification. The C₁₀-C₂₈ fatty alcohols, aldehydes and ketones are prepared by reduction, usually by hydrogenation, of the corresponding fatty acids. Advantageously, the feedstock hydrocarbons may be of C₁₀-C₂₄.

The feedstock may be also selected from lauric-myristic acid group (C₁₂-C₁₄) including milk fats, palmitic acid group (C₁₆) including earth animal fats, stearic acid group (C₁₈) including earth animal fats, linoleic acid group (unsaturated C₁₈) including whale and fish oils, erucic acid group (unsaturated C₂₂) including whale and fish oils, oleo stearic acid group (conjugated unsaturated C₁₈) including whale and fish oils, fats with substituted fatty acids (ricin oleic acid, C₁₈) such as castor oil, oils obtained from plants by gene manipulation, and mixtures of any two or more thereof.

The derivatives of natural fats may also include any of the aforementioned natural fats and derivatives, the hydrocarbon chain of which has been modified e.g. by substitution, branching or saturation.

The oils of the feedstock may be classified as crude, degummed, heat treated and RBD (refined, bleached, and deodorised) grade, depending on the level of pre-treatment and residual phosphorus and metals content. Animal fats and/or oils may include inedible tallow, edible tallow, technical tallow, floatation tallow, lard, poultry fat, poultry oils, fish fat, fish oils, and mixtures of any two or more thereof. Greases may include yellow grease, brown grease, waste vegetable oils, restaurant greases, trap grease from municipalities such as water treatment facilities, and spent oils from industrial packaged food operations, and mixtures of any two or more thereof.

According to one aspect, the feedstock comprises at least one of animal fat, animal oil, plant fat, plant oil, fish fat, fish oil, microbial oil, algae oil, waste fat, waste oil, residue fat, residue oil, a sludge originating from plant oil production. In case more than one or two or more feedstocks are used, the above may apply to all the feedstocks.

In one aspect, the feedstock or the lipid material comprises fossil based material (e.g. fossil based fats and/or oils) optionally in combination with any kind of animal and/or plant based material such as animal or plant based fats and/or oils. Indeed, the feedstock may comprise material of fossil or non-fossil origin or a mixture thereof. In another aspect, the feedstock or the lipid material does not comprise fossil based material (e.g. fossil based fats and/or oils).

In one particular aspect, the feedstock may comprise or consist of a lipid material which is separated from the distillation residue and optionally comprises distiller's corn oil (TCO).

In one particular aspect, the feedstock may comprise or consist of corn oil, and/or technical/distillers corn oil (TCO).

The feedstock of present invention comprises one or more demulsifiers. The demuslifiers may be used in any previous purification or refining process. Basically, the one or more demulsifiers may be any agent employed in order to break an emulsion into their respective phases, such as e.g. an oil-in-water emulsion into an oil and water phase respectively. In one aspect, the demulsifier may be a polysorbate based compound, such as e.g. an ethoxylated sorbitan, or e.g. Polysorbate 20 (polyoxyethylene (20) sorbitan monolaurate), Polysorbate 40 (polyoxyethylene (20) sorbitan monopalmitate), Polysorbate 60 (polyoxyethylene (20) sorbitan monostearate), Polysorbate 80 (polyoxyethylene (20) sorbitan monooleate), or any type of surfactant such as e.g. a sorbitan based compound and e.g. sorbitan monooleate and the likes, or any mixtures or combinations thereof.

In one aspect, the demulsifier is polysorbate.

According to the invention, the process may comprise contacting the feedstock with the adsorbent material. Such process step may comprise mixing the feedstock with the adsorbent material by any suitable means known in the art such as e.g. mechanical mixing or otherwise any means providing for an even distribution of the adsorbent material in the feedstock in order to allow for proper contact of the adsorbent material with the feedstock. Contacting may be for any suitable time interval such as e.g. from about 1 min to about 360 min, such as e.g. from about 5 min to about 50 min, such as e.g. from about 10 min to about 40 min, or e.g. about 35 min. In the context of contacting the feedstock with the adsorbent, a drying step may also be included therein. The drying may be conducted under vacuum. A drying step may comprise heating the mixture to a temperature in range of about 50° C. to about 150° C. such as e.g. about 80° C. to about 120° C., such as in range of about 90° C. to about 110° C., or about 100° C. The drying may be performed under reduced pressure such as e.g. at 20 mbar to about 500 mbar, such as e.g. about 30 mbar to about 250 mbar, such as e.g. about 50 mbar to about 150 mbar such as e.g. about 100 mbar. Furthermore, the drying step may be performed during a time period of about 1 min to about 90 min, such as e.g. about 5 min to about 60 min, such as e.g. about 10 min to about 30 min, such as e.g. about 20 min.

In one embodiment the feedstock may be contacted with the adsorbent material on one or more supports or surfaces such as filters which are used for separation purposes. Indeed, the filter(s) may comprise pre-coating with the adsorbent material. In such cases the feedstock does not need to be, but in specific embodiments may be, mixed together with an/the adsorbent material before filtration.

After contacting the feedstock with the adsorbent material according to the invention, the feedstock is separated from the adsorbent material. Separation may take place by any suitable method known in the art. Exemplary and non-limiting means of separation may be e.g. by any type of filtration such as e.g. by the aid of one or more filters which may be;

any type of filter medium, or

a grid, or

a net, or

a porous glass disk, or

a paper/cellulose based material, or

a membrane of any kind or based on any material,

or any combination(s) thereof.

Thus in one aspect, the filter may be regarded as a filter support as exemplified herein.

In a further aspect of the invention, the filter may be employed in combination with the adsorbent material e.g. such that the filter is pre-coated with the adsorbent material. Pre-coating may take place by any suitable method and may comprise applying the adsorbent material onto the filter. A non-limiting demonstrative example may be suspending the adsorbent material in a suitable carrier fluid, passing the suspension through a filter/filtration device/support to build a pre-coat cake on the filter/filtration support/device (e.g. a metal net). The actual fluid to be filtered (such as e.g. the feedstock treated or otherwise mixed with the adsorbent material) is then filtered through this pre-cake and the filtered particles further build up the filtration cake. Thus in one aspect, the adsorbent material may both act as a filtration aid and as the agent being capable of adsorbing at least the demulsifying agent.

In another aspect, an alternative way to perform filtration is to have the adsorbent in the fluid and build up the cake when performing the actual filtration. This method is referred to as body feed filtration. Such filtration mode may be combined with pre-coat filtration. Indeed, in one embodiment of the invention the adsorbent material is added to the feedstock before separation and/or at least one or more filters are pre-coated with the adsorbent material before filtering. In specific cases wherein the adsorbent material (i.e. a first adsorbent material) is mixed with the feedstock and a filter is pre-coated before separating the feedstock from the adsorbent material, a pre-coating material of the filter may comprise the adsorbent material (i.e. a first adsorbent material) or another adsorbent material (i.e. a second adsorbent material which is different from the first adsorbent material) or a combination thereof.

Other non-limiting means of separation is e.g. by means of one or more of centrifugation, sedimentation, settling, or decantation, or any combinations thereof.

In one aspect, the adsorbent material may be present in an amount of less than 5 wt %, less than 4 wt % or less than 3 wt % such as from about 0.1 wt % to about 3 wt % based on the weight of the feedstock. Particularly, the adsorbent may be present in an amount of from about 0.5 wt % to about 1.5 wt % based on the weight of the feedstock, or about 0.7 wt %, or about 1.5 wt %.

When the adsorbent material is combined with any type of filter such as applied onto any type of grid or net or membrane it may be present in an amount of from about 0.1 wt % to about 3 wt % based on the weight of the feedstock, such as e.g. in an amount of from about 0.5 wt % to about 1.5 wt % based on the weight of the feedstock, or about 0.7 wt %, or about 1.5 wt %.

In one aspect, the adsorbent material such as mineral based adsorbent may be present in an amount of from about 0.1 wt % to about 3 wt % or from about 0.5 wt % to about 1.5 wt % based on the weight of the feedstock, or about 0.7 wt %, or about 1.5 wt %, while also being combined with any type of filter such as applied onto any type of grid or net or membrane it may be present in an amount of from about 0.1 wt % to about 3 wt % based on the weight of the feedstock, such as e.g. in an amount of from about 0.5 wt % to about 1.5 wt % based on the weight of the feedstock, or about 0.7 wt %, or about 1.5 wt %.

As indicated herein, the feedstock may optionally be heated in any one of the individual steps of the process. Consequently, the feedstock in step i) and/or step ii) and/or step iii) may have any temperature in the range of about 15° C. to about 100° C., about 18° C. to about 80° C., about 15° C. to about 70° C., about 15° C. to about 60° C., about 15° C. to about 50° C., about 15° C. to about 40° C., about 15° C. to about 30° C., about 18° C. to about 25° C., or about 70° C. to about 90° C., or about 22° C. to about 80° C., or about 20° C. to about 80° C., or about 25° C. to about 80° C. As is also clear to a person skilled in the art, the feedstock may have ambient temperature.

In a particular aspect, the temperature of the feedstock or the feedstock/adsorbent mix during step ii) may be about 100° C. or less, about 90° C. or less, about 85° C. or less, about 80° C. or less, about 75° C. or less, about 70° C. or less, about 60° C. or less, about 50° C. or less, about 40° C. or less, or about 30° C. or less, e.g. in range of about 15° C. to about 30° C., about 20° C. to about 40° C., about 20° C. to about 22° C., or about 60° C. to about 90° C., and even more particularly in range of about 20° C. to about 24° C. or about 80° C. to about 85° C.

In a further aspect, the temperature of the feedstock or the feedstock/adsorbent mix during step iii) may be about 100° C. or less, about 90° C. or less, about 85° C. or less, about 80° C. or less, about 75° C. or less, about 70° C. or less, about 60° C. or less, about 50° C. or less, about 40° C. or less, or about 30° C. or less, e.g. in range of about 15° C. to about 30° C., about 20° C. to about 40° C., about 20° C. to about 22° C. or about 60° C. to about 90° C., and even more particularly in range of about 20° C. to about 24° C. or about 80° C. to about 85° C.

The reaction time during step ii) may be in any range of about 5 min to about 60 min, or even more than 60 min.

In a particular aspect, the reaction time during step ii) may be in any range of about 15 min to about 35 min, or even more particularly during about 20 min or during about 30 min.

In other aspects of the invention, the obtained purified feedstock may be subjected to further treatment steps. Such treatments may be e.g., but are not limited to, heat treating and/or bleaching the purified feedstock.

In one aspect, the purified feedstock is heat treated at the temperature from e.g. about 150° C. to about 300° C., or e.g. from about 200° C. to about 280° C.

In a further aspect, the process according to the invention may comprise removing or reducing the amount of water in the feedstock. Such removal of water may take place prior to contacting the feedstock with the adsorbent material and/or prior to separation of the adsorbent material from the feedstock, or alternatively after obtaining the purified feedstock.

According to the invention, the obtained purified feedstock may be combined with other types of feedstocks, optionally before or after one or more of the following: heat treating, bleaching and/or removing water as mentioned herein.

In the work leading up to this invention, the main target was to study whether and how adsorbent materials can be used for removing one or more demulsifiers from feedstocks and furthermore how different separation or filtration techniques remove a demulsifier such as polysorbate from a feedstock (e.g. TCO). It was shown that e.g. pre-coat filtration in different temperatures including suitable low temperatures enables removing demulsifiers such as polysorbate. Interesting bleaching adsorbent and/or pre-coat materials were tested, these materials being activated for increased adsorption, as pre-coat/filter aid materials usually have nonexistent or very poor adsorption properties. The results were compared to different filtration, degumming and bleaching results, and in addition to polysorbate also the usual impurities were followed (e.g. phosphorous containing compounds+metals).

In one aspect, present invention also relates to the following items:

1. A process for reducing or removing one or more demulsifiers present in a feedstock, wherein the process comprises the use of an adsorbent material, and wherein the process further comprises;
i) providing said feedstock comprising one or more demulsifiers,
ii) contacting said feedstock with the adsorbent material, and thereafter
iii) separating said feedstock from the adsorbent material,
   to thereby obtain a purified feedstock with a reduced amount of one or more demulsifiers.

2. The process according to item 1, wherein the feedstock in i) comprises a lipid material.

3. The process according to any one of the preceding items, wherein the adsorbent material comprises a surface treated mineral adsorbent, or otherwise surface activated mineral adsorbent.

4. The process according to any one of the preceding items, wherein the mineral adsorbent comprises or consist of a material based on diatomaceous earth, diatomite, perlite, bentonite, palygorskite, kaoline, kaolinite, silica, and/or sepiolite, or any combination thereof.

5. The process according to any one of the preceding items, wherein the adsorbent material has been surface activated or treated with an acid, wherein optionally the acid is e.g. sulphuric acid, hydrochloric acid, or nitric acid, or any combination thereof.

6. The process according to any one of the preceding items, wherein the lipid material comprises one or more of materials originating from any plant or animal origin, or any material based on algae or bacteria or fungal material.

7. The process according to any one of the preceding items, wherein the lipid material comprises one or more of any plant oils, plant fats, animal fats and animal oils, and mold oils, selected from e.g. rapeseed oil, canola oil, colza oil, tall oil, sunflower oil, corn oil, technical/distillers corn oil (TCO), soybean oil, hemp oil, olive oil, linseed oil, cottonseed oil, mustard oil, palm oil, palm effluent sludge (PES), arachis oil, castor oil, coconut oil, animal fats such as e.g. suet, tallow, blubber, recycled alimentary fats, starting materials produced by genetic engineering, and biological starting materials produced by microbes such as algae and bacteria and the likes or any combinations or mixtures thereof.

8. The process according to any one of items 2-7, wherein the lipid material comprises corn oil, or technical/distillers corn oil (TCO).

9. The process according to any one of the preceding items, wherein the demulsifier is selected from one or more of a polysorbate based compound, such as e.g. an ethoxylated sorbitan, or e.g. Polysorbate 20 (polyoxyethylene (20) sorbitan monolaurate), Polysorbate 40 (polyoxyethylene (20) sorbitan monopalmitate), Polysorbate 60 (polyoxyethylene (20) sorbitan monostearate), Polysorbate 80 (polyoxyethylene (20) sorbitan monooleate), or any type of surfactant such as e.g. a sorbitan based compound and e.g. sorbitan monooleate and the likes, or any mixtures or combinations thereof.

10. The process according to any one of the preceding items, wherein the separation in step iii) is filtration, optionally by means of one or more filters selected from; any type of filter medium, or

a grid, or

a net, or

a porous glass disk, or

a paper/cellulose based material, or

a membrane of any kind or based on any material,

and wherein the adsorbent material is optionally applied onto the filter,

or wherein separation is made by means of one or more of centrifugation, sedimentation, settling, or decantation.

11. The process according to any one of the preceding items, wherein the process optionally does not include or comprises further/additional degumming and/or bleaching.

12. The process according to any one of the preceding items, wherein the feedstock in i) comprises one or more demulsifiers in an amount of about 0.05-2 wt %, such as e.g. about 0.1-2 wt %, such as e.g. about 0.1-1 wt %, or more.

13. The process according to any one of the preceding items, wherein the feedstock in i) and/or step ii) and/or step iii) has any temperature in the range of about 15° C. to about 100° C., about 18° C. to about 80° C., about 15° C. to about 60° C., about 15° C. to about 40° C., about 15° C. to about 30° C., about 18° C. to about 25° C., or about 70° C. to about 90° C., or about 22° C. to about 80° C., or about 20° C. to about 80° C., or about 25° C. to about 80° C.

14. The process according to any one of the preceding items, wherein the adsorbent material is characterized by;
a) having surface area of 100 m²/g or more, and/or
b) the capability to adsorb phosphorus containing compounds and/or metals.

15. The process according to any one of the preceding items, wherein the adsorbent material has a permeability in a range from about 0.1 to about 20 darcies, or about 0.2. to about 2.5 darcies, or about 0.2 to about 1 darcies, or about 0.5 to about 1.0 darcies.

16. The process according to any one of the preceding items, wherein the particle size of the adsorbent material is in any distribution or range of about 1 μm to about 1000 μm.

17. The process according to any one of the preceding items, wherein the obtained purified feedstock further displays reduced amounts of phosphorous containing compounds and/or metals, or is essentially free of phosphorous containing compounds and/or metals.

18. The process according to any one of the preceding items, wherein the amount of the demulsifier of the purified feedstock is 0-0.3 wt % or 0.1-0.2 wt %, or below levels which may be detected by any analytical method, or the amount of the demulsifier is about 25% or less in relation to the amount of the demulsifier of the feedstock to be purified, such as e.g. 20% or less, 15% or less, 10% or less, 5% or less, 2% or less or 1% or less; and/or

the amount of phosphorus and/or metals of the purified feedstock metals is about 20% or less in relation to the amount of phosphorus and/or metals of the feedstock to be purified, such as e.g. 15% or less, 10% or less, 5% or less, 2% or less or 1% or less.

19. A purified feedstock obtainable by the process according to any of the preceding items, the purified feedstock comprising a lipid material separated from a distillation residue and further comprising a demulsifier in an amount of about 0.3 wt % or less, or below detection level of any analytical method.

20. The purified feedstock according to item 19, wherein the lipid material separated from the distillation residue comprises distiller's corn oil (TCO).

21. Use of an adsorbent material for purifying a feedstock comprising one or more demulsifiers and a lipid material separated from a distillation residue.

22. Use of the purified feedstock or any mixture thereof obtainable according to any one of items 1-18 for the preparation of a fuel, fuel component or fine chemicals.

The invention is further illustrated by the below non-limiting examples.

### EXAMPLES

All example treatments used a technical corn oil (TCO, aka distiller's corn oil) feed that contained 0.33 wt-% of polysorbate, 145 mg P/kg of phosphorous impurities and 285 mg/kg of metal impurities.

Bleaching experiments with varied adsorbent dosage: The feedstock was bleached in a typical vegetable oil bleaching protocol (see e.g. http://www.lipico.com/processes_bleaching.html). The feed was homogenized with 500 mg/kg dosage of citric acid and 0.05 wt-% water, where after the feed was mixed with 0.5, 1 or 1.5 wt-% of an acid-activated mineral adsorbent (based on sulfuric acid activated bentonite). The treatment temperature was 85° C. and time 30 min. The adsorption treatment was finalised by a drying step in vacuum where after the treatment mixture was filtered through a pre-coat bed of adsorbent (0.7% relative to feed amount). In product analysis, the removal of polysorbate was found to be directly proportional to the amount of adsorbent added and the purification mechanism can be concluded to be adsorption (Table 1). In addition, excellent purification of phosphorous and metals was observed.

TABLE 1
Purification of polysorbate, phosphorous and metals from technical
corn oil with an acid-activated mineral adsorbent in oil bleaching.

| | | | Bleaching | | |
|---|---|---|---|---|---|
| | | | product/adsorbent dosage | | |
| | | Feed | 0.5% | 1.0% | 1.5% |
| Polysorbate | wt-% | 0.33 | 0.28 | 0.23 | 0.17 |
| Phosphorous | mg/kg | 145 | 6.5 | 2.8 | 1.8 |
| Metals | mg/kg | 285 | 4.4 | 2.4 | 2.1 |

Alternatively for filtering the treatment mixture through a pre-coat bed of adsorbent, other separation methods such as sedimentation, settling and/or decantation can be used for separating the purified feedstock from the adsorbent.

Pre-Coat Filtration with Non-Activated Filter Aid Based on Diatomaceous Earth

The feedstock was mixed with 0.7 wt-% of diatomaceous earth (as the mineral based adsorbent which had not been treated with any acid) and mixed for 20 min at 80° C. Thereafter, the slurry was filtered at 80° C. on a pre-coat cake of 0.7 wt-% (relative to the feed amount) of filter aid that had been prepared by circulating the pre-coat filter aid as a slurry in high-purity oil on the filtration support. The filtration did not reduce the polysorbate content of the technical corn oil feed (0.33 wt-% before and after filtration). The phosphorous content was reduced from 145 to 35 mg/kg and metals from 285 to 45 mg/kg.

Pre-Coat Filtration with Activated Filter Aid at 80° C.

The feedstock was mixed with 0.7 wt-% of surface-activated (acid-activated) diatomaceous earth based filter aid (as the mineral based adsorbent) and mixed for 20 min at 80° C. Thereafter, the slurry was filtered at 80° C. on a pre-coat cake of 0.7 wt-% (relative to the feed amount) of the same filter aid/as the mineral based adsorbent that had been prepared by circulating the pre-coat filter aid as a slurry in high-purity oil on the filtration support. The filtration reduced the polysorbate content of the technical corn oil feed from 0.33 to 0.28 wt-%. The reduction of polysorbate at 80° C. was clear in comparison to a set of filtrations with other non-activated filter aids, in which the polysorbate content was not reduced at all. The phosphorous content was reduced from 145 to 6.4 mg/kg and metals from 285 to 27 mg/kg.

Pre-Coat Filtration with Activated Filter Aid at Room Temperature (22° C.)

The feedstock was mixed with 0.7 wt-% of surface-activated (acid-activated) diatomaceous earth based filter aid and mixed for 20 min at 22° C. Thereafter, the slurry was filtered at 22° C. on a pre-coat cake of 0.7 wt-% (relative to the feed amount) of the same filter aid that had been prepared by circulating the pre-coat filter aid as a slurry in high-purity oil on the filtration support. The filtration reduced the polysorbate content of the technical corn oil feed from 0.33 to 0.19 wt-%. Comparing the reduction of polysorbate at 80° C. and 22° C. filter aid filtrations shows a clear benefit of using lower temperatures. The examples show that polysorbate is only removed by materials, which have adsorptive properties, and that it is not removed at all by mechanical filtration. The phosphorous content was reduced from 145 to 6.4 mg/kg and metals from 285 to 27 mg/kg.

It can thus be concluded that employing lower temperatures during filtration is advantageous with respect to the amount of removed polysorbate. This is also beneficial for the quality of the resulting purified feedstock as lower temperatures result in fewer side reactions which may result in lower quality oils.

1.-22. (canceled)

23. A process for reducing or removing one or more demulsifiers present in a feedstock using an adsorbent material, optionally in an amount of 0.1 wt % to 3 wt % based on a weight of the feedstock, wherein the process comprises:
i) providing a feedstock containing one or more demulsifiers;
ii) contacting a feedstock with the adsorbent material, wherein the adsorbent material has been surface activated by acid treatment wherein the acid is selected from at least one or more of a sulphuric acid, hydrochloric acid, and/or nitric acid, and/or any combination thereof; and thereafter
iii) separating said feedstock from the adsorbent material,
to thereby obtain a purified feedstock with a reduced amount of one or more demulsifiers.

24. The process according to claim 23, wherein the feedstock in i) comprises:
a lipid material.

25. The process according to claim 23, wherein the adsorbent material comprises, or is a mineral adsorbent and optionally comprises or consists of:
a material based on at least one or more of diatomaceous earth, diatomite, perlite, bentonite, palygorskite, kaoline, kaolinite, silica, and/or sepiolite, and/or any combination thereof.

26. The process according to claim 23, wherein the feedstock or the lipid material comprises:
one or more of materials originating from any plant or animal origin, or any material based on algae or bacteria or fungal material.

27. The process according to claim 23, wherein the feedstock or the lipid material comprises:
at least one or more of any plant oils, plant fats, animal fats, animal oils, fish fats, fish oils, microbial oils, algae oils, waste fats, waste oils, residue fats, residue oils, a sludge originating from plant oil production, a fatty acid distillate, acidulated soapstock, mold oils, rapeseed oil, canola oil, colza oil, babassu oil, carinata oil, coconut butter, muscat butter oil, sesame oil, maize oil, poppy seed oil, cottonseed oil, soy oil, laurel seed oil, jatropha oil, palm kernel oil, camelina oil, tall oil, fraction of tall oil, crude tall oil, tall oil pitch, sunflower oil, corn oil, technical/distillers corn oil (TCO), soybean oil, hemp seed oil, olive oil, linseed oil, cottonseed oil, mustard oil, mustard seed oil, peanut oil, castor oil, coconut oil, palm oil, crude palm oil, palm seed oil, palm fatty acid distillate, palm oil mill effluent, arachis oil, castor oil, coconut oil, archaeal oil, bacterial oil, fungal oil, protozoal oil, algal oil, seaweed oil, oils from halophiles, poultry fat, dry rendered poultry fat, brown grease, used cooking oil, suet, lard, tallow, blubber, recycled alimentary fats, acid oil, train oil, spent bleaching earth oil, lignocellulosic based feeds, materials produced by genetic engineering, and biological materials produced by microbes, and/or any combinations or mixtures thereof.

28. The process according to claim 23, wherein the feedstock or the lipid material comprises:
corn oil, or technical/distillers corn oil (TCO).

29. The process according to claim 23, wherein the demulsifier is selected from at least one or more of a polysorbate based compound, an ethoxylated sorbitan, Polysorbate 20 (polyoxyethylene (20) sorbitan monolaurate), Polysorbate 40 (polyoxyethylene (20) sorbitan monopalmitate), Polysorbate 60 (polyoxyethylene (20) sorbitan monostearate), Polysorbate 80 (polyoxyethylene (20) sorbitan monooleate), any type of surfactant a sorbitan based compound and sorbitan monooleate, and/or any mixtures or combinations thereof.

30. The process according to claim 23, wherein the separation in step iii) is filtration, optionally by means of one or more filters selected from:
any type of filter medium, or
a grid, or
a net, or
a porous glass disk, or
a paper/cellulose based material, or
a membrane of any kind or based on any material,
and wherein the adsorbent material is optionally applied onto the filter,
or wherein separation is made by means of one or more of centrifugation, sedimentation, settling, or decantation.

31. The process according to claim 23, wherein the process does not include further/additional degumming and/or bleaching.

32. The process according to claim 23, wherein the feedstock in i) comprises:
one or more demulsifiers in an amount of 0.05-2 wt %, 0.1-2 wt %, or 0.1-1 wt %, or more.

33. The process according to claim 23, wherein the feedstock in i) and/or step ii) and/or step iii) has any temperature in a range of at least one or more of about 15° C. to about 100° C., about 18° C. to about 80° C., about 15° C. to about 60° C., about 15° C. to about 40° C., about 15° C. to about 30° C., about 18° C. to about 25° C., or about 70° C. to about 90° C., or about 22° C. to about 80° C., or about 20° C. to about 80° C., or about 25° C. to about 80° C.

34. The process according to claim 23, wherein the feedstock in step iii) has any temperature in a range of 15° C. to 100° C.

35. The process according to claim 23, wherein the adsorbent material comprises:
a) having surface area of 100 m²/g or more; and/or
b) a capability to adsorb phosphorus containing compounds and/or metals.

36. The process according to claim 23, wherein the adsorbent material has a permeability in a range from at least one or more of 0.1 to 20 darcies, or 0.2. to 2.5 darcies, or 0.2 to 1 darcies, or 0.5 to 1.0 darcies.

37. The process according to claim 23, wherein a particle size of the adsorbent material is in any distribution or range of 1 μm to 1000 μm.

38. The process according to claim 23, wherein the obtained purified feedstock displays reduced amounts of phosphorous containing compounds and/or metals, or is essentially free of phosphorous containing compounds and/or metals.

39. The process according to claim 23, wherein an amount of the demulsifier of the purified feedstock is at least one or more of 0-0.3 wt % or 0.1-0.2 wt %, or below levels which may be detected by any analytical method, or an amount of the demulsifier is 25% or less in relation to the amount of the demulsifier of the feedstock to be purified or selected from at least one or more of 20% or less, 15% or less, 10% or less, 5% or less, 2% or less or 1% or less; and/or
an amount of phosphorus and/or metals of the purified feedstock metals is 20% or less in relation to an amount of phosphorus and/or metals of the feedstock to be purified or selected from at least one or more of 15% or less, 10% or less, 5% or less, 2% or less or 1% or less.

40. A purified feedstock obtained by the process according to claim 23, wherein the purified feedstock comprises:
a lipid material separated from a distillation residue; and
a demulsifier in an amount of 0.3 wt % or less, or below an analytic detection.

41. The purified feedstock according to claim 40, wherein the lipid material separated from the distillation residue comprises:
distiller's corn oil (TCO).

42. A process of using an adsorbent material for purifying a feedstock containing one or more demulsifiers and optionally a lipid material separated from a distillation residue, the process comprising:
applying the adsorbent material to remove or reduce an amount of the one or more demulsifiers, wherein the adsorbent has been acid activated with an acid selected from at least one or more of sulphuric acid, hydrochloric acid, or nitric acid, and/or any combination thereof.

43. The process of purifying the purified feedstock of claim 23, or any mixture thereof, the process comprising:
preparing a fuel, a fuel component or a fine chemical with the purified feedstock.
